(19) United States
(12) Patent Application Publication
(10) Pub. No.: US 2012/0206799 A1
(43) Pub. Date: Aug. 16, 2012

(54) BINOCULARS WITH INTEGRATED LASER DESIGNATOR/ILLUMINATOR FOR ILLUMINATING AN OPTICAL FIELD OF VIEW

(75) Inventors: Louis F. Riley, Weston, FL (US); Juan Carlos Casas, Coral Gables, FL (US)

(73) Assignee: Juan Carlos Casas, Coral Gables, FL (US)

(21) Appl. No.: 13/371,868

(22) Filed: Feb. 13, 2012

Related U.S. Application Data
(60) Provisional application No. 61/441,681, filed on Feb. 11, 2011.

(51) Int. Cl. G02B 23/18

(52) U.S. Cl. 359/418

(57) ABSTRACT

Binoculars with an integrated laser light source capable of illuminating the optical field of view through the binoculars to provide concise and effective viewing under limited visibility conditions. The integrated light source generates a coherent laser light beam that has variably adjustable divergence.

### CROSS REFERENCE TO RELATED APPLICATIONS

This application claims the benefit of U.S. Provisional Application No. 61/441,681, filed Feb. 11, 2011, the contents of which are incorporated herein by reference.

### BACKGROUND OF THE INVENTION

Binoculars are used to aid in distance viewing but have a drawback in offering limited visibility of night. Commercially-available lighting accessories such as the Laser Genetics ND-3 can be added via after-market mounts. However, shortcomings with this approach include the problem of the light beam being misaligned with the optical field of view of the binoculars due to parallax error over the range of viewing distances inherent in the typical operation of binoculars.

### BRIEF DESCRIPTION OF THE INVENTION

The present invention provides binoculars with an integrated designator/illuminator capable of illuminating the optical field of view through the binoculars to provide concise and effective viewing under limited visibility conditions. The integrated designator/illuminator generates a coherent laser light beam that has variably adjustable divergence and is generated by a laser light source integrated within what can otherwise be considered standard binoculars.

According to a first aspect of the invention, the binoculars include a pair of housings pivotally coupled to each other along a pivot axis. Each housing includes an eyepiece that contains an ocular lens, and each housing includes an objective lens disposed at an end thereof opposite the eyepiece. The ocular and objective lenses cooperate to define a field of view of the binoculars, and the ocular and objective lenses can be adjusted to focus an image of the field of view. The binoculars further include a laser light source integrated with the binoculars and adapted to generate a laser light beam, emit the laser light beam through an aperture of the binoculars, and produce a lighted spot within the field of view of the binoculars at a distance from the binoculars. The laser light source and the aperture are disposed between the housings, and the laser light beam has an adjustable focus so that the lighted spot may be a designator spot or a larger illuminator spot within the field of view of the binoculars at a distance from the binoculars.

Another aspect of the invention is a method of using binoculars comprising the elements described above. Such a method includes energizing the laser light source to generate the laser light beam and emit the laser light beam through the aperture, and adjusting the focus of the laser light beam to produce the lighted spot within the field of view of the binoculars so that the lighted spot is either a designator spot or a larger illuminator spot.

According to yet another aspect of the invention, a method of using binoculars more generally entails energizing a laser light source integrated with the binoculars to generate a laser light beam and emit the laser light beam through an aperture of the binoculars, and adjusting the focus of the laser light beam to produce a lighted spot within a field of view of the binoculars at a distance from the binoculars so that the lighted spot is either a designator spot or a larger illuminator spot.

A technical effect of the invention is the ability of the laser light source to be centrally integrated between the objective lenses of the binoculars so that the emitted laser beam is always within the field of view and parallax errors are kept to a minimum. The coherent laser beam generated by the laser light source is preferably a continuous wave (CW) whose divergence may be adjusted to obtain a designator-type collimated beam spot size to point at a target within the field of view of the binoculars, or an illuminator-type flood beam to illuminate all or a selected area of the field of view.

Other aspects and advantages of this invention will be better appreciated from the following detailed description.

### BRIEF DESCRIPTION OF THE DRAWINGS

FIGS. 1 and 2 are perspective views of binoculars having an integrated designator/illuminator capability in accordance with an embodiment of the present invention.

FIG. 3 is a perspective view of the binoculars of FIGS. 1 and 2 and represents the conventional operation of the binoculars when the field of view of the binoculars is a magnified area at a distance away from the binoculars.

FIG. 4 is a perspective view of the binoculars similar to FIG. 3 but further illustrating a collimated laser “designator” or spot beam within the binoculars' field of view.

FIG. 5 is a perspective view of the binoculars similar to FIG. 3 but further illustrating a divergent laser “illuminator” or flood beam within the binoculars' field of view.

### DETAILED DESCRIPTION OF THE INVENTION

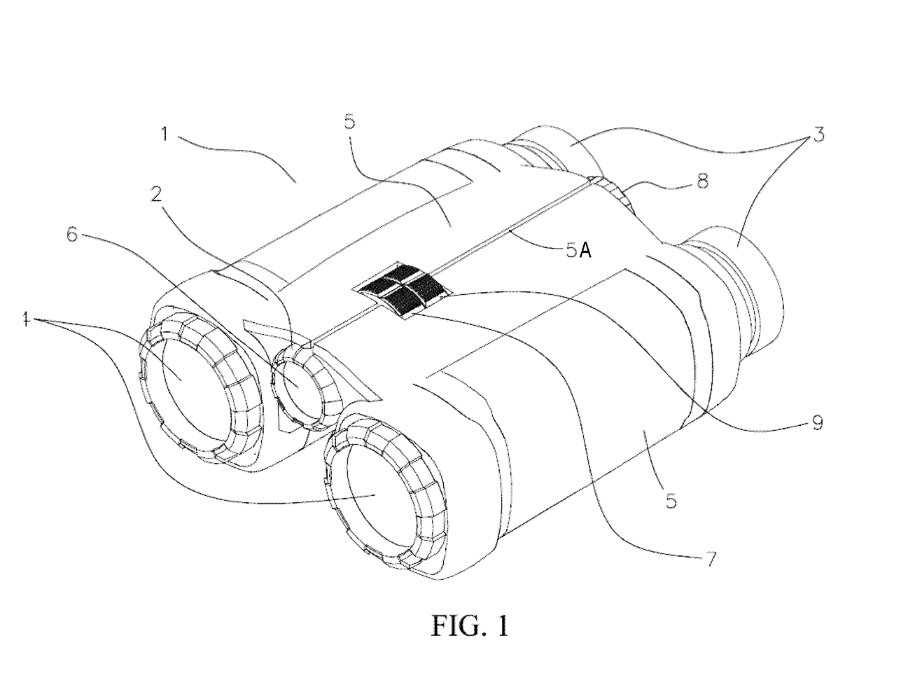

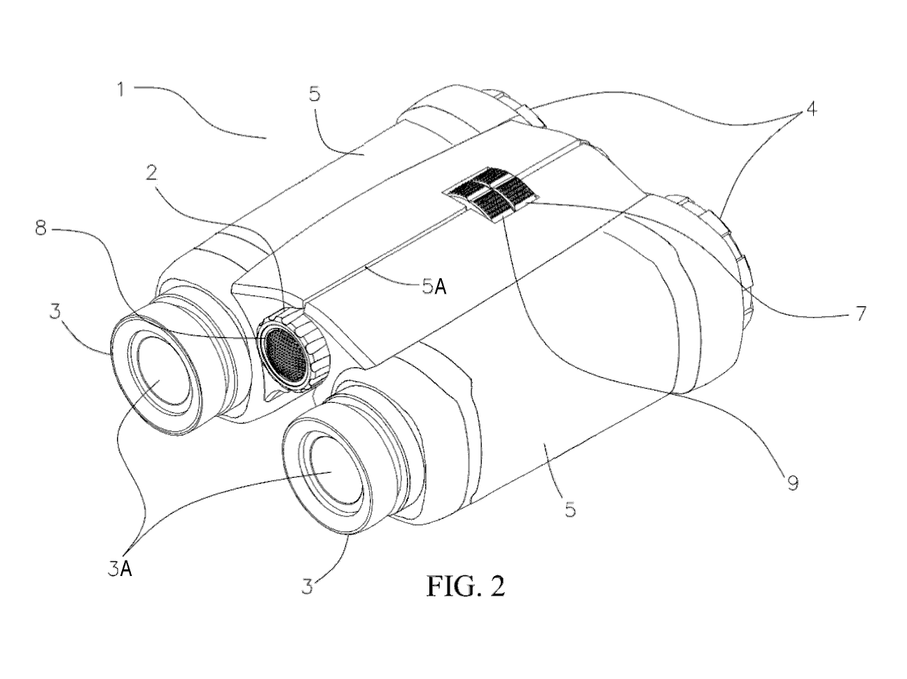

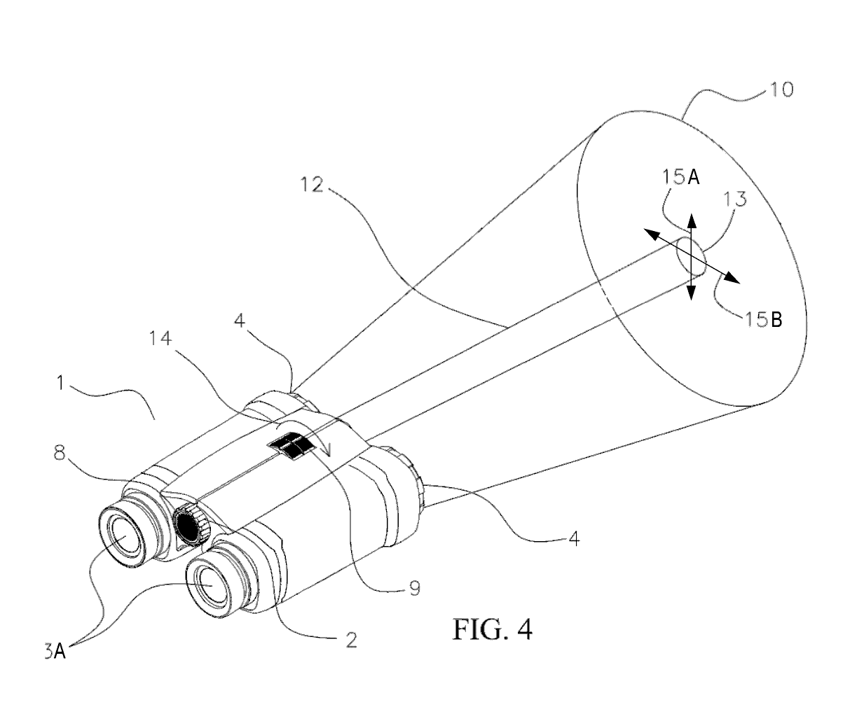

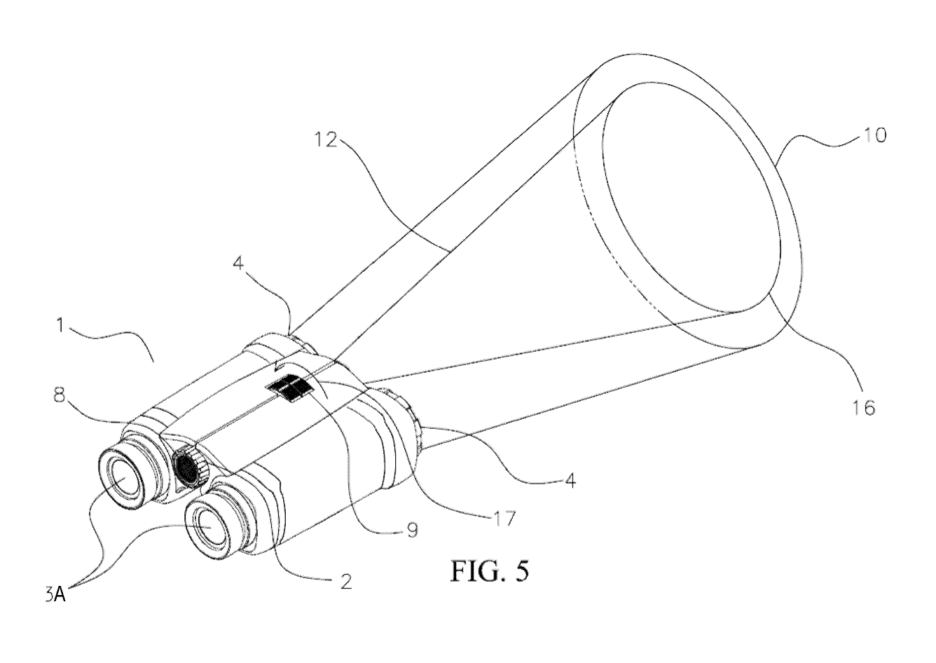

FIGS. 1 and 2 schematically represent binoculars 1 that comprise an integrated coherent laser light source 2 capable of generating a continuous wave (CW) laser beam 12 (FIGS. 4 and 5) whose coherent nature provides for greater light intensities over much farther distances as compared to LEDs, incandescent bulbs, and other more traditional incoherent lighting technologies. As will be discussed below, such a capability enables the laser beam 12 to serve as a designator/illuminator for selectively lighting (designating) a limited portion of the optical field of view of the binoculars 1 or lighting (illuminating) a much larger portion of the field of view, and optionally the entire field of view.

The laser source 2 may be a diode pumped solid state (DPSS) laser that generates, for example, a laser beam 12 having a wavelength of about 532 nm (green) to match the human eye's peak day and night light sensitivity. Commercial examples of products using this type of technology include the ND-3 and ND-5 series laser designators available from Laser Genetics, Inc., which utilize a powerful green laser light diode in combination with a precision optical collimator. However, it is foreseeable that the binoculars 1 could utilize a laser diode or laser source of any other visible color, for example, a wavelength that coincides with the peak sensitivity of imaging devices such as night vision goggles.

Referring again to FIGS. 1 and 2, the binoculars 1 include a pair of lens housings or barrels 5, each preferably having a watertight construction. The barrels 5 are pivotally coupled together in any conventional manner so as to define a pivot axis 5A therebetween, which approximately coincides with a gap shown between the barrels 5. Each barrel 5 comprises an eyepiece 3 containing an ocular lens 3A, and an objective lens 4 disposed at an end of the barrel 5 opposite the eyepiece 3. The binoculars 1 include a rotating dial 7 for focusing the images presented in the ocular lenses 3A. The operation of the dial 7 and the manner in which focusing is performed can be consistent with what is already known in the art, and therefore will not be discussed in any further detail.

The laser light source 2 is preferably fully integrated with the binoculars 1, meaning that the light source 2 is enclosed and housed within the body of the binoculars 1 as opposed to being manufactured as an entirely separate unit for mounting on a variety of other types of devices. The laser light source 2 is disposed between the barrels 5 and oriented so that the laser beam 12 generated by the light source 2 and emitted through an aperture 6 between the objective lenses 4 has an axis that can be parallel to the axes of the barrels 5 and to their shared pivot axis 5A. More particularly, the light source 2 is offset from and between the axes of the barrels 5 and their pivot axis 5A so as to be above the axes of the barrels 5 and immediately below their pivot axis 5A. In this manner, parallax error over the range of viewing distances of the binoculars 1 is minimized. The light source 2 is preferably mounted so that its location does not vary relative to the pivot axis 5A, such that the barrels 5 can be pivoted about their pivot axis 5A without causing the light source 2 to move relative to the pivot axis 5A. However, the light source 12 may be configured so that the vertical and/or horizontal orientation of the axis of its laser beam 12 can be adjusted by making appropriate adjustments to the optical system of the light source 2, so that the position of a lighted spot produced by the laser beam 12 within the field of view of the binoculars 1 can be moved and repositioned within the field of view. Suitable means for accomplishing this type of adjustment to the light source 2 are known in the art and will not be discussed in any detail here.

According to a preferred aspect of the invention, the binoculars 1 are equipped with means for altering the size of the laser beam 12 generated by the light source 2. As such, the binoculars 1 are shown as being further equipped with a rotating dial 9 for controlling the divergence of the beam 12, and therefore the size (cross-sectional area) of a spot lighted by the beam 12 at some distance from the binoculars 1. In this manner, the light source 2 is adapted to produce a coherent beam 12 that can be variably focused as a collimated beam for lighting (designating) a limited portion of the binocular's field of view with a bright collimated spot useful for target designation (FIG. 4), as well as a diverging beam for lighting (illuminating) a larger portion of the binocular's field of view and useful for target and area illumination (FIG. 5). The adjustable nature of the light source 2 allows for an infinite level of focusability between a minium designator spot diameter size and a maximum illuminator spot diameter size. The coherent nature of the laser beam 12 offers the advantage of designating or illuminating a target at much farther distances than traditional lighting accessories.

Fully rotating the dial 9 in one direction preferably results in the laser beam 12 being fully collimated to have a diameter substantially equal to the aperture 6, but preferably no smaller. In preferred embodiments, this collimation limit constrains the beam size such that it is always diverging, to some degree, because a converging beam could raise eye safety issues. Conversely, fully rotating the dial 9 in the opposite direction causes the beam 12 to diverge, resulting in the diameter of the beam 12 becoming increasingly greater than the aperture 6. Optical systems that utilize one or more lenses to focus the coherent light emitted by the laser diode of the light source 2 in order to achieve the desired variable focus of the laser beam 12 are known in the art, and therefore will not be discussed in any detail here. For example, such a capability is provided with the aforementioned ND-3 and ND-5 series laser designators available from Laser Genetics, Inc.

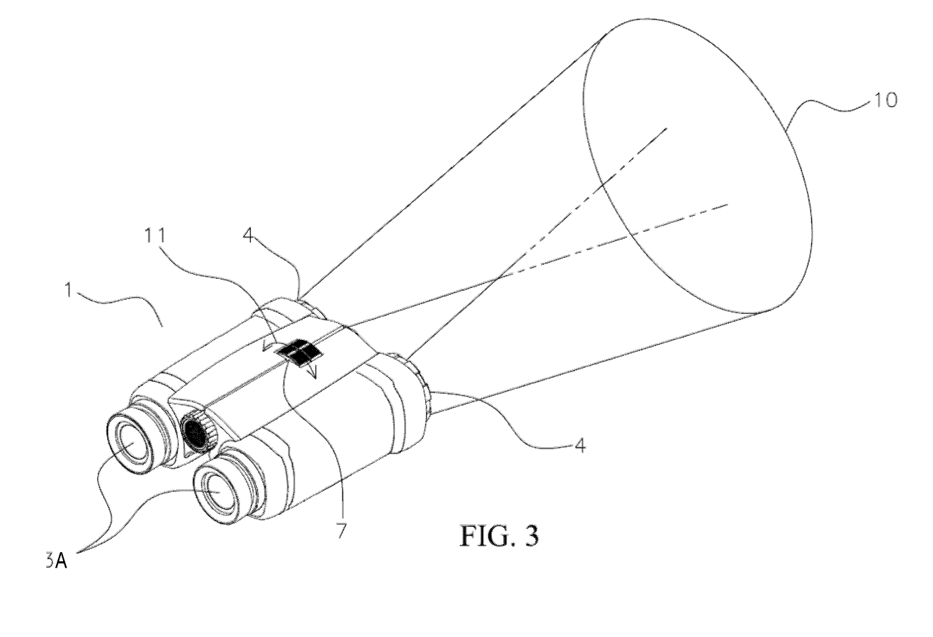

FIGS. 3 through 5 are perspective views of the binoculars 1 of FIGS. 1 and 2, and represent an example of a field of view 10 of the binoculars 1 when used to magnify an object at distance. As well understood in the art, the field of view 10 is magnified and viewed through the objective lenses 4 via the ocular lenses 3A, and the magnified image of the field of view 10 is focused via rotating the dial 7 as indicated by the arrow 11. FIG. 3 represents the operation of the binoculars 1 with the light source 2 de-energized so that the laser beam 12 is not emitted. FIG. 4 represents the binoculars 1 with the light source 2 energized as a result of pressing a power button 8 located between the eyepieces 3 (FIG. 2). The beam 12 is represented as being focused to produce a collimated designator spot 13 centrally located within the field of view 10 as a result of the dial 9 being rotated in a direction indicated by the arrow 14. As previously noted and represented by the arrows 15A and 15B, the light source 2 and its optical system can be configured so that the vertical and horizontal position of the spot 13 within the field of view 10 can be adjusted. FIG. 5 represents the binoculars 1 with the light source 2 projecting the laser beam 12 over a much larger portion of the field of view 10 as a result of the focus of the beam 12 being adjusted with the dial 9 to produce a divergent illuminator spot 16. FIG. 5 represents this adjustment to the beam focus as being achieved by rotating the dial 9 in the direction indicated by the arrow 17. Though not indicated, the vertical and horizontal position of the larger illuminator spot 16 within the field of view 10 may also be adjustable.

While the invention has been described in terms of a preferred embodiment, it is apparent that other forms could be adopted by one skilled in the art. For example, the invention could be implemented with binoculars that differ in appearance and construction from the embodiments shown in the Figures, the functions of each component of the invention could be performed by components of different construction but capable of a similar (though not necessarily equivalent) function, and appropriate materials could be substituted for those noted. Therefore, the scope of the invention is to be limited only by the following claims.

1. Binoculars comprising:
a pair of housings pivotally coupled to each other along a pivot axis, each housing comprising an eyepiece that contains an ocular lens and comprising an objective lens disposed at an end thereof opposite the eyepiece, the ocular and objective lenses cooperating to define a field of view of the binoculars;
means for adjusting the ocular and objective lenses to focus an image of the field of view; and
a laser light source integrated with the binoculars and adapted to generate a laser light beam, emit the laser light beam through an aperture of the binoculars, and produce a lighted spot within the field of view of the binoculars at a distance from the binoculars, the laser light source and the aperture being disposed between the housings, the laser light beam having an adjustable focus so that the lighted spot may be a designator spot or a larger illuminator spot within the field of view of the binoculars at a distance from the binoculars.

2. The binoculars according to claim 1, further comprising a rotatable dial for adjustably focusing the laser light beam.

3. The binoculars according to claim 1, wherein the laser light source is offset from the pivot axis of the housings.

4. The binoculars according to claim 1, wherein the laser light source is configured so that pivoting of the housings about the pivot axis thereof does not cause the laser light beam to move relative to the pivot axis.

5. The binoculars according to claim 1, wherein the laser light beam is adjustable between a fully collimated beam having a diameter no smaller than the aperture and a diverging beam having an increasingly larger diameter than the aperture.

6. The binoculars according to claim 1, wherein the laser light source is adjustable to enable moving of the lighted spot within the field of view of the binoculars.

7. The binoculars according to claim 6, wherein the laser beam is vertically and horizontally movable within the field of view of the binoculars.

8. The binoculars according to claim 1, wherein the laser light source is fully integrated with the binoculars.

9. A method of using the binoculars of claim 1 to project the laser beam on an object within the field of view, the method comprising:
energizing the laser light source to generate the laser light beam and emit the laser light beam through the aperture; and
adjusting the focus of the laser light beam to produce the lighted spot within the field of view of the binoculars at a distance from the binoculars, the lighted spot being either the designator spot or the larger illuminator spot.

10. The method according to claim 9, further comprising adjusting the position of the lighted spot within the field of view of the binoculars.

11. A method comprising:
energizing a laser light source integrated with binoculars to generate a laser light beam and emit the laser light beam through an aperture on the binoculars; and
adjusting the focus of the laser light beam to produce a lighted spot within a field of view of the binoculars at a distance from the binoculars, the lighted spot being either a designator spot or a larger illuminator spot.

12. The method according to claim 11, wherein, the laser light source and the aperture are disposed between a pair of housings that are pivotally coupled to each other along a pivot axis, each housing comprises an eyepiece that contains an ocular lens and comprises an objective lens disposed at an end thereof opposite the eyepiece, and the ocular and objective lenses cooperate to define the field of view of the binoculars.

13. The method according to claim 11, wherein the adjusting step comprises adjusting the laser light beam between a fully collimated beam having a diameter no smaller than the aperture and a diverging beam having an increasingly larger diameter than the aperture.

14. The method according to claim 11, further comprising adjusting the position of the lighted spot within the field of view of the binoculars.
